(19) United States
(12) Patent Application Publication
(10) Pub. No.: US 2013/0319949 A1
(43) Pub. Date: Dec. 5, 2013

(54) FLOATED SOLIDS SEPARATION

(71) Applicants: Kyle Booth, Oklahoma City, OK (US); Mike Cosby, Moore, OK (US); Mark Fosshage, HoHoKus, NJ (US); Scott Poe, Oklahoma City, OK (US); Dave Schlegel, Oklahoma City, OK (US)

(72) Inventors: Kyle Booth, Oklahoma City, OK (US); Mike Cosby, Moore, OK (US); Mark Fosshage, HoHoKus, NJ (US); Scott Poe, Oklahoma City, OK (US); Dave Schlegel, Oklahoma City, OK (US)

(21) Appl. No.: 13/876,372

(22) PCT Filed: Sep. 27, 2011
(86) PCT No.: PCT/US11/53543

§ 371 Date: Aug. 21, 2013

Related U.S. Application Data
(60) Provisional application No. 61/386,992, filed on Sep. 27, 2010.

(51) Int. Cl. B01D 21/00; C02F 1/24

(52) U.S. Cl. CPC B01D 21/0027; C02F 1/24
USPC 210/703; 210/538; 210/523; 210/526; 210/299; 210/298

(57) ABSTRACT

A method and apparatus for removing solids separated from wastewater, or algae from algal solution, using an improved dissolved air flotation system that incorporates a slowly rotating cylindrical sieve at the end of an upward sloping beach to drain free water from the float, which has been pushed up the beach and onto the rotating sieve, and a doctor blade that removes the thickened float from the rotating sieve is disclosed.

This invention relates to removal of solids, which have been separated from water slurries, including wastewater or algal solutions, using an improved dissolved air flotation (DAF) system, and in particular, relates to a process and apparatus that enhances the dryness of solids removed from a dissolved air flotation system.

### BACKGROUND

Dissolved air flotation (“DAF”) systems have been in use for over 100 years. DAF systems are used to separate total suspended solids (TSS)—fats, oils and greases (FOG), and other insoluble impurities from wastewater. DAF removes these solids suspended in water using microbubbles that interact with the particles to cause them to float, and the floated particles are then skimmed and separated. There are numerous DAF designs and permutations thereof, including such trade names as BAF, CAF, EAF, and GEM. Generally, DAF systems have a technique to introduce microbubbles into a water stream, which cause suspended materials to float to the surface of a vessel to achieve liquid-solid separation. The wastewater first enters a low shear mixing pipe flocculator where coagulants and flocculants may be introduced to increase the particle size along with “whitewater.” Whitewater is a mixture of a portion of the DAF effluent, which has been saturated with atmospheric air. The wastewater and whitewater mixture then enters the separation vessel, creating microbubbles. In an improved DAF system, the wastewater and whitewater mixture enters the separation vessel across the length of the system. The velocity of the water is significantly reduced to maximize separation potential. Inside the separation vessel, the microbubbles, which have attached to the particle surface affect the particle density, and cause the suspended solids to float to the surface. This floated material is often called the float, sludge, or top sludge. The float contains the separated solids, air, and water. The float is skimmed off the surface by a chain and flight skimming system, scoop, or other mechanism, into a top cone. Sand and other heavy grit particles in the vessel settle at the bottom. The particles that have settled at the bottom can be removed by a chain and flight or augur system, for example. In improved systems, the sand and other heavy grit particles in the vessel settle into cone bottoms, where a timer function controls their removal. The “clean” water is continuously removed through one or more weirs into an effluent box. In an improved system, the “clean” water is continuously removed at several points inside the vessel and passes over pipe weirs. From the effluent box, gravity feeds the clarified water out of the effluent box to be further processed, discharged, and/or re-used in such places as for the whitewater for the DAF system.

The presently available systems only separate and skim the separated solids. The float is pushed up and over a beach directly into a hopper. The float created by these existing systems contain a very high water content, and removing free water is a multi-step process that presents several problems. The float must be further dewatered in a separate step, for example, by plate and frame press, belt press, screw press, centrifuge, or decant tank. The float is often hauled to a separate location for further processing, but the excess water increases the cost of transport. Additionally, the process of moving the float, either by gravity or by pump, can shear the float and make free water more difficult and expensive to remove. This additional processing adds extra space and energy requirements to the liquid-solid separation process.

For the foregoing reasons, there is a need for a method and apparatus that can remove excess water from the float, thereby thickening the float, in an efficient manner that uses minimal space and energy and does not damage the solids.

### SUMMARY

The invention is directed to a method and apparatus that efficiently achieves liquid-solid separation by a DAF system and contemporaneously removes free water. The invention can be directed to a method of separating algae harvested from its growth medium, for separating solids in dairy wastewater, or for the treatment of other wastewater. This invention uses a mechanism that pushes the floated solids (“float”) onto a thickening beach on a rotating sieve. The rotating sieve drains the float of excess water as it slowly rotates. The rotating sieve also carries the float to a doctor blade, which removes the float and allows it to fall into a separated solids vessel. The water drained from the float is captured in a free water vessel and can be directed to reprocessing or combined with effluent water created by the DAF system. This improved DAF system “thickens” the float in an efficient manner without damaging it and requires minimal space and energy.

The invention comprises an apparatus for separating top sludge from wastewater treated by a dissolved air flotation system, which comprises: a skimmer for pushing top sludge onto an upward-sloping beach; a rotating sieve adjacent to the beach comprising a cylindrical sieve that rotates on its lateral axis, wherein the rotating sieve is positioned adjacent to said beach, rotates at a speed that enhances the amount of free water drained, and is made of membrane, mesh, woven fabric, or other porous material to enhance the amount of free water drained while retaining top sludge; and a doctor blade for removing top sludge conveyed over said rotating sieve into a top sludge container. Optimally, the rotating sieve contains a water-spraying device for cleaning the rotating sieve on a periodic basis. The invention may further comprise external plates or rollers that can apply pressure to the top sludge against the rotating sieve to further squeeze and force water to drain from the top sludge.

The invention comprises an apparatus for separating algae from an algal solution treated by a dissolved air flotation system, which comprises: a skimmer for pushing algae onto an upward-sloping beach; a rotating sieve adjacent to the beach comprising a cylindrical sieve that rotates on its lateral axis, wherein the rotating sieve is positioned adjacent to said beach, rotates at a speed that enhanced the amount of free water drained, and is made of membrane, mesh, woven fabric, or other porous material to enhance the amount of free water drained while retaining algae; and a doctor blade for removing algae conveyed over said rotating sieve into an algae container. Optimally, the rotating sieve contains a water-spraying device for cleaning the rotating sieve on a periodic basis. The invention may further comprise external plates or rollers that can apply pressure to the algae against the rotating sieve to further squeeze and force water to drain from the algae.

The invention comprises a rotating sieve assembly for use with a dissolved air flotation system comprising: a rotating sieve for draining free water, which rotates at a speed that enhances the amount of free water drained, and is made of membrane, mesh, woven fabric, or other porous material to enhance the amount of free water drained while retaining separated solids; a free water vessel for collecting free water drained from said rotating sieve; a doctor blade for removing separated solids conveyed over said rotating sieve into a separated solids container.

The invention comprises a method for separating top sludge from wastewater treated by a dissolved air flotation system, which comprises: skimming top sludge onto an upward-sloping beach; conveying top sludge onto a rotating sieve adjacent to the beach comprising a cylindrical sieve that rotates on its lateral axis, wherein the rotating sieve is positioned adjacent to said beach, rotates at a speed that enhances the amount of free water drained, and is made of membrane, mesh, woven fabric, or other porous material to enhance the amount of free water drained while retaining top sludge; draining free water from top sludge while the top sludge travels along the outer face of said rotating sieve; removing top sludge from said rotating sieve with a doctor blade; and collecting top sludge removed from said rotating sieve. The invention may further comprise applying pressure to top sludge against the rotating sieve to further squeeze and force water to drain from the top sludge.

The invention comprises a method for separating algae from an algal solution treated by a dissolved air flotation system, which comprises: skimming algae onto an upward-sloping beach; conveying algae onto a rotating sieve adjacent to the beach comprising a cylindrical sieve that rotates on its lateral axis, wherein the rotating sieve is positioned adjacent to said beach, rotates at a speed that enhances the amount of free water drained, and is made of membrane, mesh, woven fabric, or other porous material to enhance the amount of free water drained while retaining algae; draining free water from algae while the algae travels along the outer face of said rotating sieve; removing algae from said rotating sieve with a doctor blade; and collecting algae removed from said rotating sieve. The invention may further comprise applying pressure to the algae against the rotating sieve to further squeeze and force water to drain from the top sludge.

### BRIEF DESCRIPTION OF THE DRAWINGS

The invention is better understood by reference to the accompanying drawings where:

FIG. 1 is a cross-section view of the improved DAF system incorporating the invention, and a side view of the air saturation system;

FIG. 2 is a prospective view of the improved DAF system incorporating the invention of FIG. 1;

FIG. 3 is a cross-section view of the rotating sieve assembly of FIG. 1; and

FIG. 4 is a diagram schematically showing a flow representing the invention.

FIG. 5 is a cross-section view of an alternative improved DAF system incorporating the invention, and a side view of the air saturation system.

FIG. 6 is a view of the thickened float collection system which can be added to the improved DAF system.

### DETAILED DESCRIPTION OF THE DRAWINGS

“Top sludge,” “sludge,” or “float” is a mixture of separated materials, air, and water that has been floated to the surface by microbubbles using a DAF system. The separated materials can comprise of total suspended solids, including fats, oils, greases, insoluble impurities, or any other solids suspended in water or wastewater. It is advantageous to separate the solids from free water before further processing.

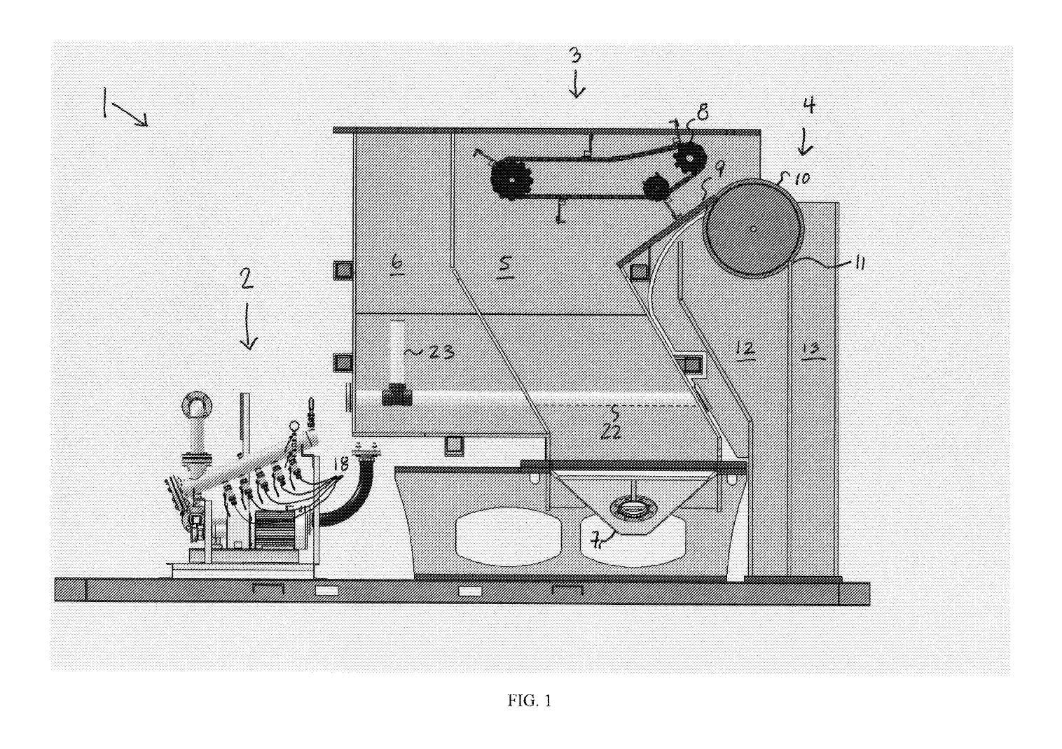

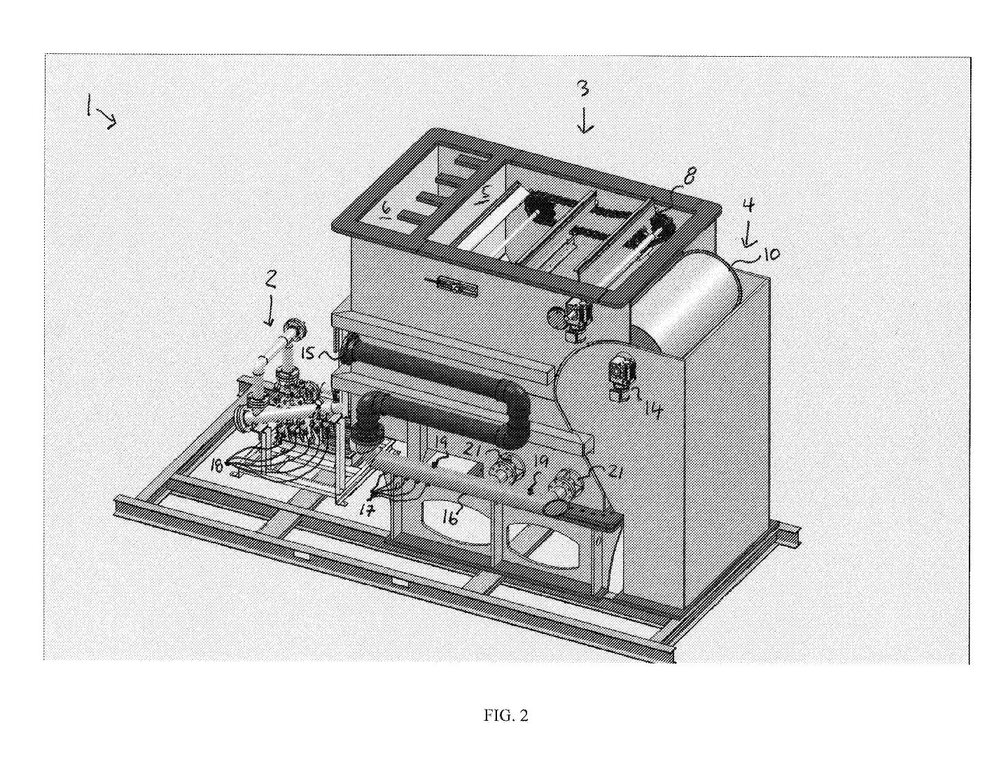

FIGS. 1 and 2 show an embodiment of the improved dissolved air flotation (DAF) system 1. The DAF system 1 comprises an air saturation system 2, a separation unit 3, and rotating sieve assembly 4. The air saturation system 2 creates whitewater by saturating atmospheric air into water. The air saturation system 2 has whitewater outputs 18 from which the whitewater exits. The separation unit 2 has two main compartments, a separation vessel 5 and effluent box 6. The liquid/solids separation occurs in the separation vessel 5 and the clarified liquid is moved into the effluent box 6. The separation vessel has a heavy impurities exit 7, through which sand and other grit may exit. The side walls of the separation vessel 5 may be offset at an angle, one of which is shared with the effluent box 6. A skimmer 8 is positioned at the top of the separation vessel to remove the separated solids. The beach 9 is positioned at an upward-sloping angle at the exit of the separation vessel. The rotating sieve assembly 4, which thickens the solids removed from the separation vessel, comprises a rotating sieve 10, doctor blade 11, free water vessel 12, and separated solids vessel 13. The speed of the rotating sieve is controlled by a speed mechanism 14. The influent is fed into the DAF system through the influent pipe 15, which feeds into to a low shear mixing pipe flocculator 16. Coagulants may be added to the influent prior to feeding it into the low shear mixing pipe flocculator 16. The low shear mixing pipe flocculator 16 or feed pipe has whitewater injection ports 17, through which whitewater, generated by the air saturation system 2, is injected. The whitewater comes from whitewater outputs 18, which are connected to the whitewater injection ports 17 via whitewater injection tubes (not illustrated). The low shear mixing pipe flocculator 16 has, flocculant ports 19 through which flocculants are injected via flocculant injection tubes (not illustrated). The low shear mixing pipe flocculator 16 or feed pipe connects to the separation vessel through wastewater entry ports 21. Inside the separation vessel 5, clean water pipes 22 progressively extract the clarified water and deposit the clarified water into the effluent box 6 through clarified water spouts 23. Pipe weirs (not illustrated) fit over the clarified water spouts 23. Accumulated effluent water is gravity removed from the effluent box 6 through pipes in the floor of the effluent box (not illustrated).

The influent, which consists of solids suspended in liquid, is fed from the influent pipe 15 into a low shear mixing pipe flocculator 16 or feed pipe. Whitewater, which has been created by an air saturation system 2 is injected into the low shear mixing pipe flocculator 16, to be mixed with the liquid-solid suspension which has been fed into the low shear mixing pipe flocculator 16 via the influent pipe 15. Coagulants and/or flocculants, which enhance the separation of the solids, may also be injected into the liquid-solid suspension through the low shear mixing pipe flocculator 16. The influent combined with whitewater enters the separation vessel 5 across the length of the system. The velocity of the water is reduced as it enters the separation vessel and the dissolved air creates microbubbles, which attach to the surface of the suspended solids and cause them to float to the surface, creating a top layer of floated materials, air, and water (the “float”). Optionally, one or more plate separators (not illustrated), which maximize liquid-solids separation efficiency may be placed inside the separation vessel, above the waste water entry ports 21 and below the surface of the liquid. A skimmer 8 removes the float that has accumulated at the surface of the separation vessel and pushes the float up the beach 9 and onto the adjacent rotating sieve 10. As the sieve rotates, the float is conveyed along the outer surface of the sieve, while free water drains into the free water vessel 12. The float thickens as the water drains from it while it travels across the top of the rotating sieve. Optionally, external plates or rollers (not illustrated) can be positioned on top of the rotating sieve 10 to thin the thick layer of solids deposited on the rotating sieve. The thickened float is removed from the rotating sieve by a doctor blade 11, and falls into a separated solids vessel 13, hopper, conveyor, or dumpster, to be stored, transferred for further processing, or hauled away. The free water drained from the rotating sieve can be routed into the separation vessel 5 for reprocessing or combined with the effluent water extracted from the DAF system. Optionally, a shower (not illustrated) can be placed inside the rotating sieve to clean solids that are blocking the holes before engaging the beach. The separation vessel 5 has a heavy impurities exit 7 that allows heavier impurities that do not float, such as sand or other grit, to exit the system. The clarified water in the separation vessel that has been extracted of its solids is continuously removed at several points by clean water pipes 22 and delivered into an effluent box 6. From the effluent box 6, some of the clean water is routed back to the air saturation system 2 to create whitewater, and the rest of the clean water feeds out of the system.

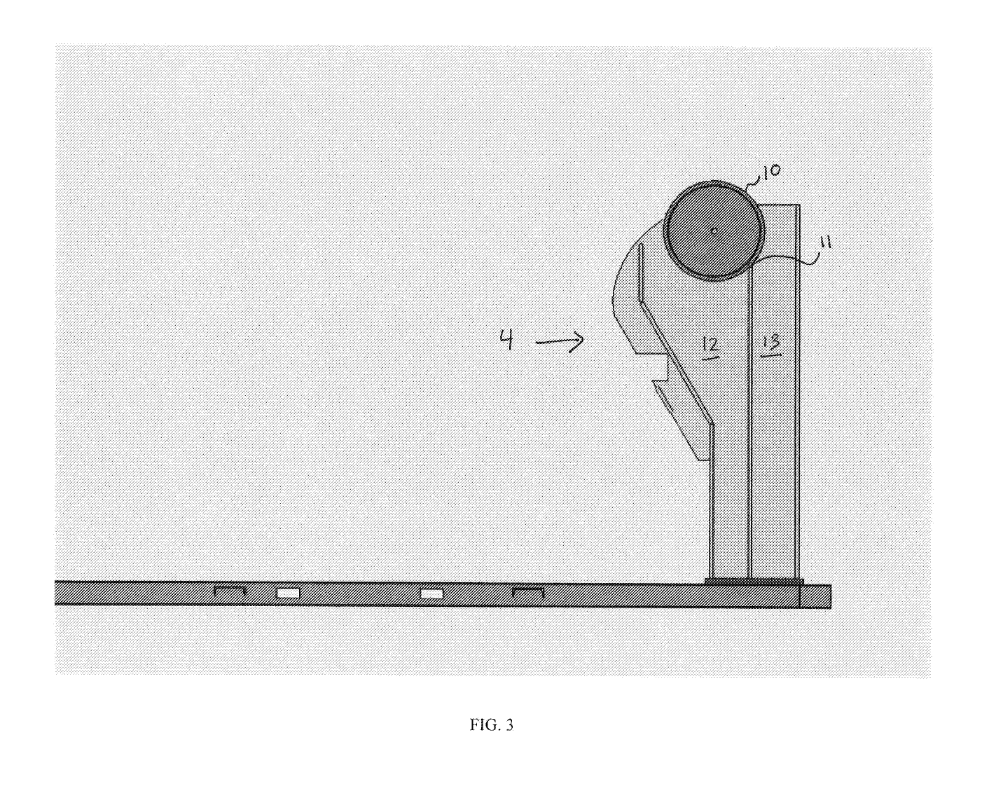

FIG. 3 shows an embodiment of the invention as a modular system that may be retrofitted onto an existing DAF system, which comprises a rotating sieve assembly 4. The rotating sieve 10 is positioned directly next to the beach of the existing DAF system, creating a tight seal between the thickening beach of the rotating sieve and the beach. The rotating sieve 10 is also positioned so that its top curve extends the length of the upward-sloping beach, to increase the amount of time for the float to drain over the sieve. A free water vessel 12 is placed directly below the rotating sieve 10 to capture free water that has been drained from the float. The thickened float is removed from the thickening beach on the face of the rotating sieve by a doctor blade 11, and falls into a separated solids vessel 13.

The air saturation system 2 creates whitewater by dissolving gas into liquid by pressurizing the air and liquid so that the air dissolve into the liquid. A preferred air saturation system is a Nikuni regenerative turbine pump, which minimizes the chemicals used in DAF processing. Preferably, the air is pressurized into clean water from the free water vessel 12, effluent box 6, or other clean water source.

The influent is preferably fed directly into a low shear mixing pipe flocculator 16 through the influent pipe 15, which are both located outside of the separation vessel. The influent that is fed into the low shear mixing pipe flocculator may be treated with coagulants and flocculants, depending on the type of solids suspended in the wastewater, which increase the size of the solids. Whitewater from the air saturation system 2 is injected into the low shear mixing pipe flocculator 16, creating a mixture of whitewater and influent.

The influent injected with whitewater is introduced into the separation vessel 5 across the length of the system. As it enters the separation vessel, the velocity of the water is significantly reduced. Inside the separation vessel, microbubbles develop from the pressurized air within the whitewater and attach to the surface of the suspended solids. With the help of the microbubbles, the suspended solids float to the surface of the water.

As illustrated in FIGS. 1 and 2, preferably, the side walls of the separation vessel are angled at 60° to enhance the separation efficiencies.

The separation vessel may contain plate separators (not illustrated), depending on the application, which allow intermediate separation surfaces that reduce the distance that the separated solids must travel. The plate separators also maximize liquid-solids separation efficiency.

The float that has accumulated on top of the water inside the separation vessel is removed using a skimmer 8, such as a chain and flight skimmer, scoop, or a top-rigged mechanism that pushes the float like a hoe across the surface of the liquid. The preferred skimming mechanism is a chain and flight skimmer that continuously pushes the float to the exit of the separation vessel and up a beach.

After the float has been skimmed off the surface of the water, it is pushed onto the beach 9. The beach 9 comprises an upward-sloping surface from which excess water can be drained while the float travels up the beach. The beach itself can be perforated allowing additional free water to drain while the float moves up the beach. The beach can also comprise a perforated conveyor belt system, made out of teflon, plastic, or other material, positioned and powered by multiple shafts. The conveyor belt simultaneously drains the float of free water and conveys the float to the separated solids vessel. The beach can also be extended with a cylindrical rotating sieve 10. The rotating sieve 10 should be positioned directly next to the beach 9, creating a tight seal to allow the transfer of solids onto the beach and prevent solids from falling into the free water vessel 12. The rotating sieve should also be placed so that the top curve of the sieve extends the length of the beach, enhancing the amount of time for the float to drain. The rotating sieve can be constructed with an outer skin made of wedgewire, mesh screen, woven fabric, or other perforated materials having various opening sizes. The selection of the sieve size and make-up of the sieve will vary based upon the application and the size of the solids. An alternative non-limiting embodiment of the sieve includes a conveyer belt (not illustrated). The optimum selection for a given application would allow maximum drainage of water through the sieve while minimizing the amount of solids that pass through the sieve. The preferred embodiment is a rotating sieve placed at the end of a solid beach, thereby extending it. The speed at which the rotating sieve rotates is selected to allow the maximum drainage of free water. It is preferred that the rotating sieve rotates slowly, because it provides more time for free water to drain without agitating the solids, but the selected speed can be determined by the type of solid that is separated and the material from which the rotating sieve is made.

A shower (not illustrated) can be placed inside the rotating sieve 10 to clean the screen by delivering a shower of water in the general area between the doctor blade 11 and the beach 9. The shower rinses the rotating sieve after the solids are removed and before additional solids are picked up to assure that proper drainage will occur. The source water from the shower may come from the free water vessel 12 or another source.

In addition, multiple external plates or rollers (not illustrated) can be added on top of the rotating sieve in order to thin the thick layer of solids deposited on the rotating sieve. This allows more free water to be in contact with the screen of the sieve, and therefore drain. The plates or rollers are adjustable so that their distance from the screen can be optimized. If the plates or rollers are too close to the screen, they can force solids through the sieve. If the plates or rollers are positioned too far from the screen, they will not provide any benefit. If the particles are very fragile, then plates or rollers will not be used.

The speed of the rotating sieve can be controlled by various means. It is preferable for the rotation speed to be controlled by a variable frequency drive that can be adjusted for optimum results.

The water content contained in the float varies based upon the specific application and other variables such as the nature of the solids being separated, the particle size, and types of coagulant and flocculant chemistry applied. The thickness of the float can be optimized by taking these factors into account, as well as adjusting the type of screen used to construct the outer skin of the rotating sieve, the speed at which the sieve rotates, and the use of external plates or rollers.

Preferably, the vessels of the improved DAF system can be constructed of polypropylene or stainless steel, Polypropylene is preferred because it is lightweight and non-corrosive, can handle a wide pH range and high TDS (Total Dissolved Solids), has high saltwater tolerance, has high temperature tolerance, and provides chemical treatment flexibility. In addition, a polypropylene construction has and heavy duty construction and no structural size limitation.

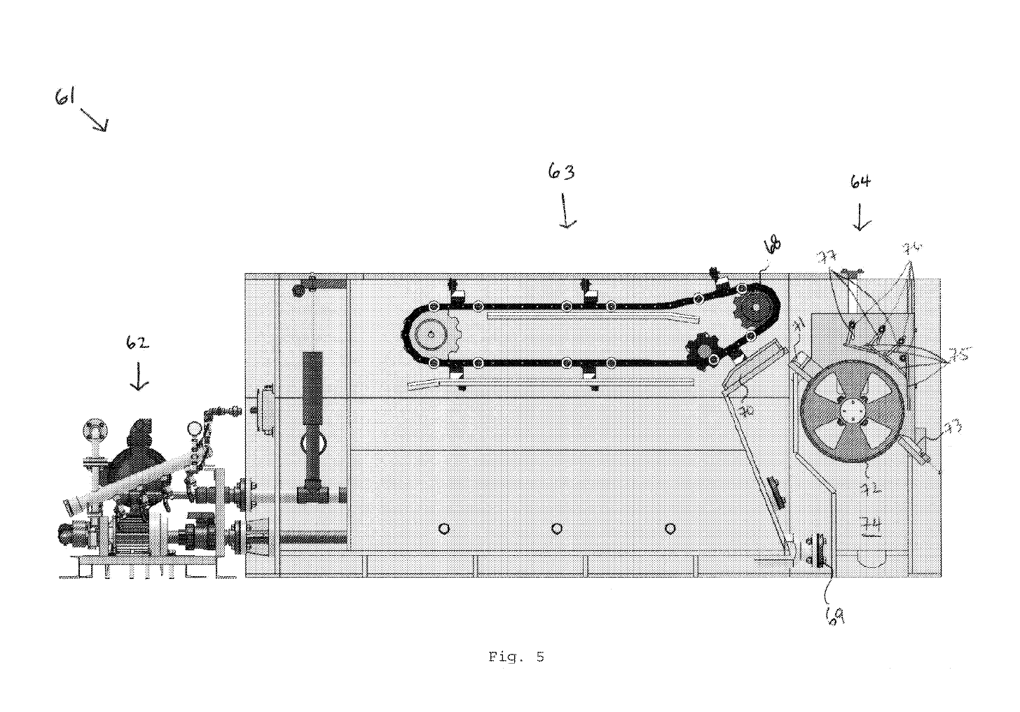

FIG. 5 shows an alternative non-limiting embodiment of the improved dissolved air flotation (DAF) system 61. The DAF system 61 comprises an air saturation system 62, a separation unit 63, and a rotating sieve assembly 64. The separation unit 63 comprises a skimmer 68 positioned at the top to remove the separated solids and a heavy impurities exit 69. The DAF beach 70 is positioned at an upward-sloping angle at the exit of the separation unit. The rotating sieve assembly 64, which thickens the solids removed from the separation unit, comprises a receiving beach 71, a rotating sieve 72, a doctor blade 73, and a free water vessel 74. The receiving beach 71 may be adjusted to create a tight seal or a gap between the DAF beach 70 and the receiving beach 71. The rotating sieve assembly 64 may further comprise one or more compression plates 75 that thins the thick layer of solids draining on the rotating sieve 71. The distance of the compression plates 75 from the rotating sieve 71 are adjustable using pins 76 that can be moved along plate guidance slots 77.

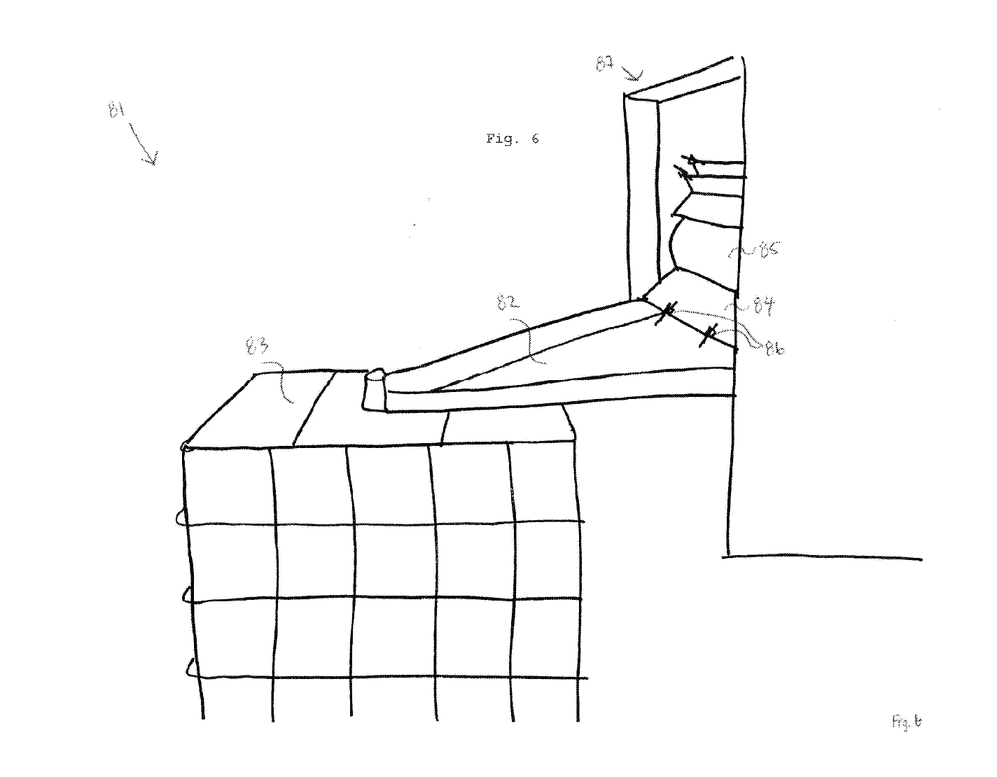

FIG. 6 shows a thickened float collection system 81. The thickened float collection system 81 may be attached or adjacent to a rotating sieve assembly 87. The thickened float collection system comprises a collection tray 82 and a storage or transportation container 83. The collection tray 82 is attached or adjacent to a doctor blade 84 that removes the thickened float from a rotating sieve 85. The collection tray 82 may be attached to the doctor blade 84 by connection pins 86. The collection tray 82 catches the thickened float after it has been removed from the rotating sieve 85 by a doctor blade 84. The thickened float flows from the doctor blade 84 onto the collection tray 82, which directs the thickened float into the container 83. The thickened float can then be transported in the container 83 for further processing at another location.

The shower feature, type of screen used to construct the outer skin of the rotating sieve, and the speed at which the sieve rotates discussed above may be applied to FIG. 5.

In addition, compression plates 75 can be added along the top of the rotating sieve 72 in order to thin the thick layer of solids deposited on rotating sieve. The compression plates 75 apply pressure to the thickening float, and allow more free water to drain from the rotating sieve 72. The distance of the compression plates 75 from rotating sieve 72 are adjustable using pins 76 that can be moved along plate guidance slots 77. The compression plates 75 are adjustable so that their distance from the screen can be optimized. If the compression plates are too close to the screen, they can force solids through the sieve. If the compression plates are positioned too far from the screen, they will not provide any benefit. If the particles in the floated solids are very fragile, then plates should not be used. An alternative non-limiting embodiment, includes one or more external rollers (not illustrated) placed along the top of the rotating sieve in place of or in addition to the compression plates 75.

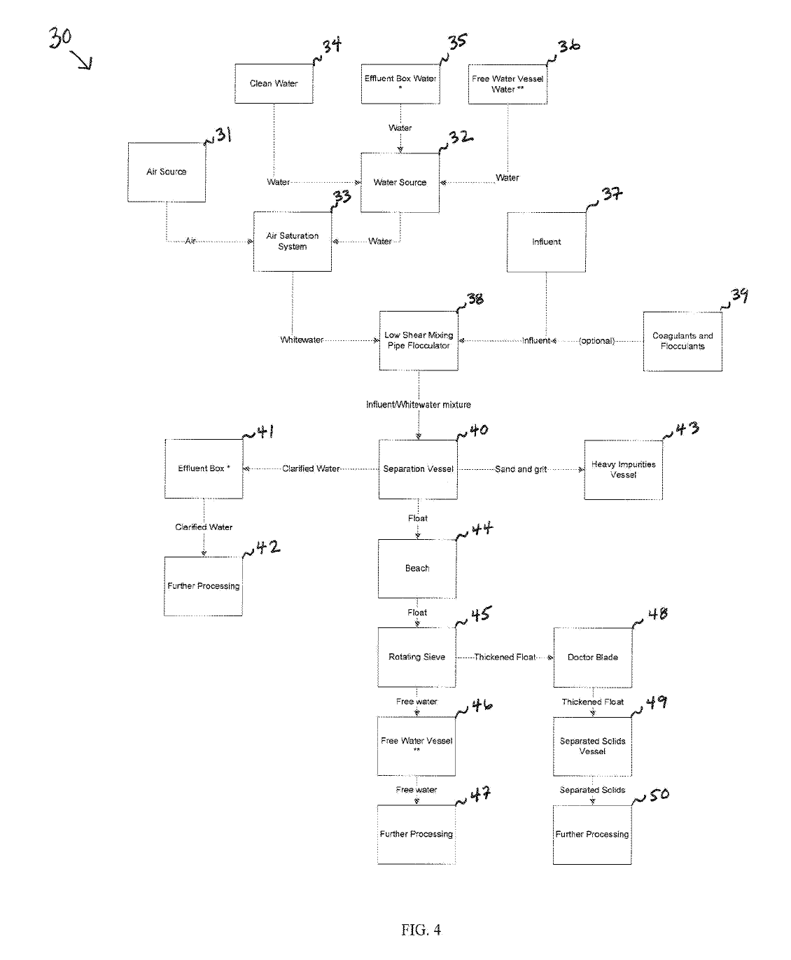

FIG. 4 shows an example of the flow of the influent according to the invention. The diagram 30 schematically shows a flow representing the invention. Air from air source 31 is combined with water from water source 32 in an air saturation system step 33 to create whitewater. The water in the water source can come from clean water 34, from effluent box water 35 (which has been routed from effluent box 41), or from free water vessel water 36 (which has been routed from the free water vessel 46). The whitewater from the air saturation system step 33 is combined with the influent 37, which comprises the suspended solids to be separated from the liquid, in a low shear mixing pipe flocculator step 38. Coagulant and flocculant addition steps 39 may be used to enhance separation of the solids in the influent. The influent/whitewater mixture exits the low shear mixing pipe flocculator step 38 and enters a separation vessel step 40. Within the separation vessel step 40, the suspended solids are floated to the surface of the liquid by microbubbles released from the whitewater. Clarified water is extracted from the separation vessel step 40 and moved into an effluent box step 41. From the effluent box step, clarified water can be removed for further processing 42, or become effluent box water step 35 to be used to create whitewater. Sand, grit, and other heavy impurities exits the separation vessel step 40 and into a heavy impurities vessel step 43. The suspended solids which have floated to the top in the separation vessel step 40 are skimmed off the surface of the liquid and onto a beach during beach processing step 44. The float is pushed onto a rotating sieve for a thickening beach step 45, which thickens the float and allows free water to drain into the free water vessel processing step 46. The free water in the free water vessel step 46 may then be removed for further processing 47, or enter the free water vessel water step 36 to be used to create whitewater. The rotating sieve thickens the float while it rotates and carries the thickened float to a doctor blade step 48 which removes the separated solids and allows them to fall into a separated solids vessel processing step 49. The separated solids may then be removed for further processing 50.

The invention has many advantages. First, the invention reduces the water content in the separated solids by 30-80%, depending on the specific application. For consumers that must haul away the solids after processing using a DAF system, this will cut their hauling costs significantly since the amount of water remaining is significantly less than existing system. This offers very large economic savings. Second, this invention requires a smaller separated solids storage tank. For consumers who cannot or would not be able to afford the hauling costs and would be forced to dewater the solids, by either centrifuge or a type of press, the invention removes the need for that extra unit operation. This invention provides significant savings in capital expense, physical space required, energy consumed, and labor used to operate the typically intensive dewatering process. Third, the integrity of the float is protected because the dewatering process occurs contemporaneously. Coagulants and flocculants are often used to create larger particles, but these flocculated particles are fragile. Over time, these flocculated particles degrade and lose their shape. When they are pumped or conveyed, the flocculated particles can be sheared and broken apart. When the particle sizes are reduced, it becomes more difficult to dewater the particles. It is advantageous to remove free water as quickly as possible, and without pumping. However, this is extremely challenging to do with a multi-step process. However, the invention provides immediate free-water drainage at the exit of the separation vessel, and no shearing of the particle occurs. Since the rotating sieve gently transfers and drains the float simultaneously, damage to the flocculated particles is prevented. By contemporaneously draining free water and protecting the integrity of the float, the thickness of the float removed from the DAF is improved. A “thicker” float is easier and cheaper to store or process because the excess water has been removed. Finally, the invention is versatile. It can be retrofitted onto existing DAF systems or built into new DAF systems.

### Algae Harvesting

The invention may be used to harvest algae for biofuel. The algae is typically grown in large water raceways. As the algae grows, it needs to be harvested. The DAF system can efficiently and effectively harvest the algae, separating it from the water and concentrating the algal solids. After the algae is harvested, it is further processed to extract the oil within the algae for use as biofuel. Many of the extraction methods require algae concentrates above 10% for the extraction methods to work. The dryer the harvested algae, the better the extraction methods work. Current DAF systems are capable of harvesting the algae and achieving between 3-5% algal solids. The wide range is based upon several major factors: type of algae, age of algae (which affects particle size), type and amount of chemistry used to increase the algae particle size, and other operational variables. The invention thickens the algae particles and improves the concentration of the solids to 8-15%.

The algae suspended in its liquid medium is pumped into the DAF system. The algae that is floated to the top of the separation vessel by the microbubbles is skimmed from the surface and pushed onto the thickening beach. The algae is drained of its free water while it is conveyed along the outer surface of the rotating sieve. The drained algae is scraped from the rotating sieve by a doctor blade and collected for further processing.

### Dairy Wastewater Processing

The invention may also be used to pretreat a dairy plant's wastewater prior to discharge to, for example, a city Public Owned Treatment Works (POTW). Treatment of the dairy wastewater with a DAF system reduces the organic and TSS load to the POTW and reduces the cost impact for the dairy imposed by the POTW. Generally, the dairy wastewater is normalized and adjusted to a certain pH in an equalization tank. A coagulant and a flocculant are injected into the wastewater prior to pumping it into the DAF to cause the suspended particles to coagulate and bridge (or flocculate) into larger particles, which are easier to separate in the DAF. After the wastewater is pumped into the DAF, the DAF system separates the particles by using the microbubbles to lift them to the surface. The TSS level in a typical dairy is between 1500-2500 mg/L prior to processing, and the effluent of the DAF is typically contains less than 250 mg/L concentration of solids. The nature of these solids typically yields a sludge which is 3-6% solids and the rest is moisture. While the 3-6% of solids equals approximately 30,000-60,000 mg/L concentration, the solids still contain excessive water. The dairy will typically need to dispose of these solids, and in the majority of cases, disposal of the solids means trucking the sludge to an off site landfill, land application, or otherwise. The more water in the sludge, the higher the hauling costs. It is preferable for the dairy to thicken or dewater the solids further in order to reduce the cost of transport. Typically, the solids are thickened using centrifuge, plate and frame filter press, belt press, or screw press as a separate step. The invention is a more efficient, and therefore, cheaper, process for thickening the solids.

### Wastewater Processing

The invention may also be used to separate solids from wastewater from a variety of industries, including: bacon, beverage, canning, cheese, confection, dressing/sauces, gelatin, poultry, meat packing, pet food, potato, rendering, vegetable, hazardous waste, industrial laundry, military, municipal, petrochemical, pharmaceutical, plating and machining, pulp and paper, biological, and semiconductor. The general principal is the same as the above applications. The wastewater is treated with coagulants and flocculants, and mixed with whitewater before it is pumped into the separation vessel. The separated solids float to the surface of the water and are either skimmed or scooped off the top onto a beach. The invention thickens the solids more efficiently, and in a more cost-effective manner than the currently available DAF systems.

We claim:

1. An apparatus for separating floated solids using a dissolved air flotation system having a beach, comprising a float thickener adjacent to the beach.

2. The apparatus of claim 1 wherein the float thickener comprises a rotating sieve.

3. The apparatus of claim 2 wherein the rotating sieve comprises a cylindrical sieve that rotates on its lateral axis.

4. The apparatus of claim 1 wherein the float thickener comprises a conveyer belt.

5. The apparatus of claim 1 wherein the float thickener comprises a membrane, metal mesh, woven fabric, or other porous material for draining free water from the floated solids.

6. The apparatus of claim 5 further comprising a container to catch free water drained from the floated solids.

7. The apparatus of claim 5 further comprising a doctor blade for removing thickened floated solids from the float thickener.

8. The apparatus of claim 5 further comprising a container to collect thickened floated solids removed by the doctor blade.

9. The apparatus of claim 1 further comprising a floated solids compressing mechanism in proximity to the float thickener.

10. The apparatus of claim 9 wherein the floated solids compressing mechanism comprises one or more plates.

11. The apparatus of claim 9 wherein the floated solids compressing mechanism comprises one or more rollers.

12. Apparatus of claim 1 further comprising a water-spraying device for cleaning the float thickener.

13. An apparatus for separating top sludge from wastewater using a dissolved air flotation system having a beach, comprising a float thickener adjacent to the beach.

14. The apparatus of claim 13 wherein the float thickener comprises a rotating sieve.

15. The apparatus of claim 14 wherein the rotating sieve comprises a cylindrical sieve that rotates on its lateral axis.

16. The apparatus of claim 13 wherein the float thickener comprises a conveyer belt.

17. The apparatus of claim 13 wherein the float thickener comprises a membrane, metal mesh, woven fabric, or other porous material for draining free water from the separated top sludge.

18. The apparatus of claim 13 further comprising a top sludge compressing mechanism in proximity to the float thickener.

19. The apparatus of claim 18 wherein the top sludge compressing mechanism comprises one or more plates.

20. The apparatus of claim 18 wherein the top sludge compressing mechanism comprises one or more rollers.

21. An apparatus for separating algae from algal solutions using a dissolved air flotation system having a beach, comprising a float thickener adjacent to the beach.

22. The apparatus of claim 21 wherein the float thickener comprises a rotating sieve.

23. The apparatus of claim 22 wherein the rotating sieve comprises a cylindrical sieve that rotates on its lateral axis.

24. The apparatus of claim 21 wherein the float thickener comprises a conveyer belt.

25. The apparatus of claim 21 wherein the float thickener comprises a membrane, metal mesh, woven fabric, or other porous material for draining free water from the separated algae.

26. The apparatus of claim 21 further comprising an algae compressing mechanism in proximity to the float thickener.

27. The apparatus of claim 26 wherein the algae compressing mechanism comprises one or more plates.

28. The apparatus of claim 26 wherein the algae compressing mechanism comprises one or more rollers for compressing algae.

29. A float thickener assembly that engages the floated solids output of a dissolved air flotation system comprising a float thickener adjacent to the beach.

30. An apparatus for separating floated solids using a dissolved air flotation system having a beach and a float thickener for separating solids from wastewater from processing bacon, beverages, canning, cheese, confections, dressings, sauces, gelatins, poultry, meat packing, pet food, potatoes, rendering, vegetables, hazardous waste, industrial laundry, military waste, municipal, petrochemicals, pharmaceuticals, plating and machining industry, pulp and paper, biological industry, or semiconductors industry.

31. A method for separating floated solids generated a dissolved air flotation system comprising the steps of:
a. conveying floated solids from the dissolved air flotation system to an adjacent float thickener having an outer face, wherein the floated solids are carried by the outer face of said float thickener; and
b. thickening the floated solids by separating free water using said float thickener.

32. The method of claim 31 wherein the float thickener comprises a rotating sieve that moves at a speed that maximizes separation of free water.

33. The method of claim 31 wherein the float thickener comprises a conveyer belt that moves at a speed that maximizes separation of free water.
